(19) United States
(12) Patent Application Publication
(10) Pub. No.: US 2011/0121740 A1
(43) Pub. Date: May 26, 2011

(54) LED LIGHTING SYSTEM AND POWER SYSTEM THEREOF

(75) Inventor: Cheng Te Shih, Taipei (TW)

(73) Assignee: Darfon Electronics Corp., Taoyuan (TW)

(21) Appl. No.: 12/697,634

(22) Filed: Feb. 1, 2010

(30) Foreign Application Priority Data
Nov. 24, 2009 (TW) 098139898

(51) Int. Cl. H05B 37/02

(52) U.S. Cl. 315/185 R; 315/307

(57) ABSTRACT

An LED lighting system including an LED device, a current-balancing device, a comparing device, a power device, and a control device is provided. The current-balancing device generates a feedback voltage based on the operation condition of the LED device. The comparing device compares the feedback voltage with a reference voltage and accordingly generates a compared result. The power device is used for providing a DC voltage to the LED device. The control device generates a control signal based on the compared result. The power device adjusts the DC voltage according to the control signal.

### BACKGROUND OF THE INVENTION

1. Field of the Invention

The present invention relates generally to power systems. More specifically, the present invention relates to power systems for LED lighting systems.

2. Description of the Prior Art

With the advancement of technologies, electronic products are more and more popular in commercial, public, and household fields. Besides the function and outward appearance, the security and durability of electronic products are also taken seriously. How to prevent users from being hurt by improper designs or damages of electronic products is an issue to which many manufacturers pay much attention. There have been many security specifications aimed at this issue.

For instance, in an electronic product, higher voltages that may hurt the user generally exist at the part closer to the end for receiving the commercial power. According to some security specifications, these circuits located at the high voltage side must be isolated from the other parts that users can touch. Further, proper isolation must be set between circuits located at the high voltage side and the low voltage side in the electronic product.

Please refer to FIG. 1(A), which illustrates the block diagram of a typical LED lighting source with its power system. The voltage converting circuit 12 is used for converting the AC voltage provided by the commercial power port 10 into a DC voltage required by the LED unit 14. Generally, the voltage converting circuit 12 belongs to the aforementioned high voltage side, and the LED unit 14 belongs to the aforementioned low voltage side.

In traditional LED lighting systems, the value of the DC voltage V_{DC} outputted by the voltage converting circuit 12 is fixed. However, in actual applications, the cross-voltage needed by every single LED when it is lighten might be different from other LEDs. To ensure every LED in the LED unit 14 has sufficient cross-voltage, the DC voltage V_{DC} provided by the voltage converting circuit 12 is typically set higher than the voltage actually required by the LED unit 14.

As shown in FIG. 1(B), most traditional LED lighting systems includes a comparing unit 16 and a boost/buck unit 18 at the low voltage side. The comparing unit 16 is used for detecting the voltages at the low voltage end of each series of LEDs. The boost/buck unit 18 is adjusted by the detected results. The boost/buck unit 18 provides compensating voltages between the output port of the voltage converting circuit 12 and each series of LEDs in the LED unit 14, so as to adjust the cross-voltages respectively received by each series of LEDs.

However, power is wasted if the DC voltage V_{DC} is set higher than the actual requirement. Besides, because of having to receive considerably high voltages and currents, the boost/buck unit 18 generally consumes much power and occupies a large space. In the trend of emphasizing saving energy and small size nowadays, the circuit architecture utilizing the boost/buck unit 18 as shown in FIG. 1(B) is not ideal.

### SUMMARY OF THE INVENTION

A new structure for the power system of LED light sources is provided. By adjusting the circuit at the high voltage side according to the operation current of LEDs, the power system according to the invention can achieve the effect of providing proper voltage for LEDs without needing a boost/buck circuit.

One embodiment according to the invention is an LED lighting system including an LED device, a current balancing device, a comparing device, a power device, and a control device. The current balancing device is coupled to the LED device and used for generating a feedback voltage based on an operation condition of the LED device. The comparing device is coupled to the current balancing device and used for comparing the feedback voltage with a reference voltage and generating a comparing result. The power device provides a DC voltage to the LED device. The control device is coupled between the comparing device and the power device. The control device generates a control signal based on the comparing result. The power device optionally adjusts the DC voltage according to the control signal.

Another embodiment according to the invention is a power system for driving an LED device including a current balancing device, a comparing device, a power device, and a control device. The current balancing device is coupled to the LED device and used for generating a feedback voltage based on an operation condition of the LED device. The power device provides a DC voltage to the LED device. The control device is coupled between the comparing device and the power device. The control device generates a control signal based on the comparing result. The power device optionally adjusts the DC voltage according to the control signal.

The power system according to the invention can be widely applied in various electronic products that utilize LEDs as light sources. The advantage and spirit of the invention may be understood by the following recitations together with the appended drawings.

### BRIEF DESCRIPTION OF THE APPENDED DRAWINGS

For a more complete understanding of the present invention and the advantages thereof, reference is now made to the following description in conjunction with the accompanying drawings in which:

FIG. 1(A) and FIG. 1(B) illustrate the block diagram of a typical LED lighting source with its power system.

FIG. 2(A)˜FIG. 2(E) illustrate the LED lighting system in the first embodiment according to the invention.

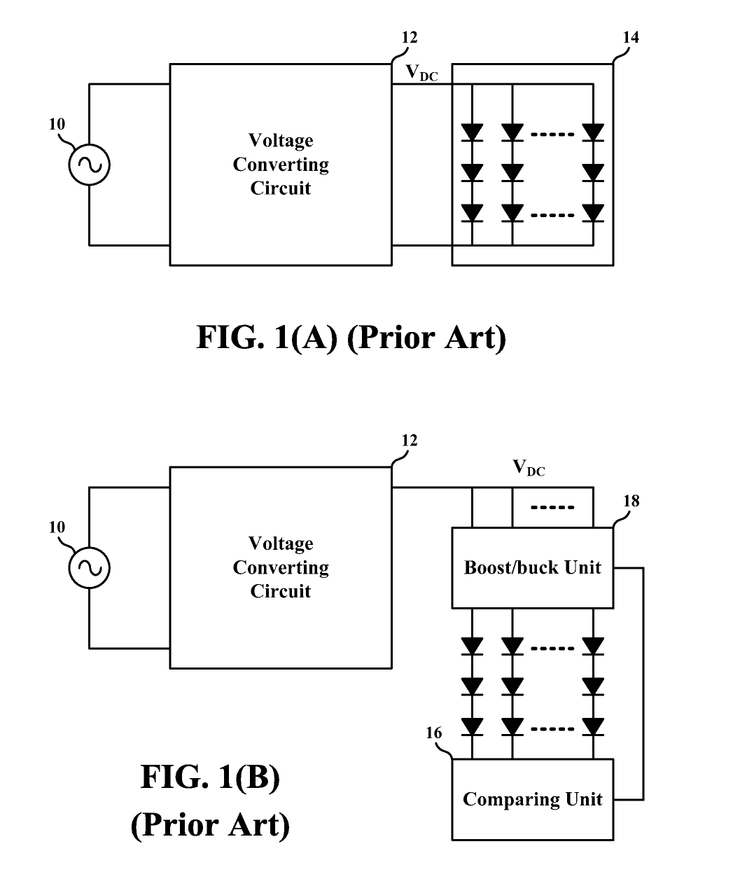

### DETAILED DESCRIPTION OF THE INVENTION

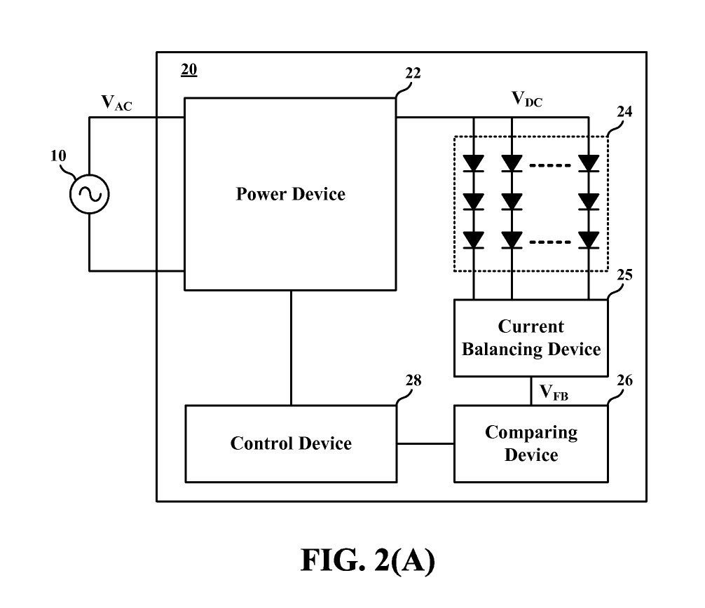

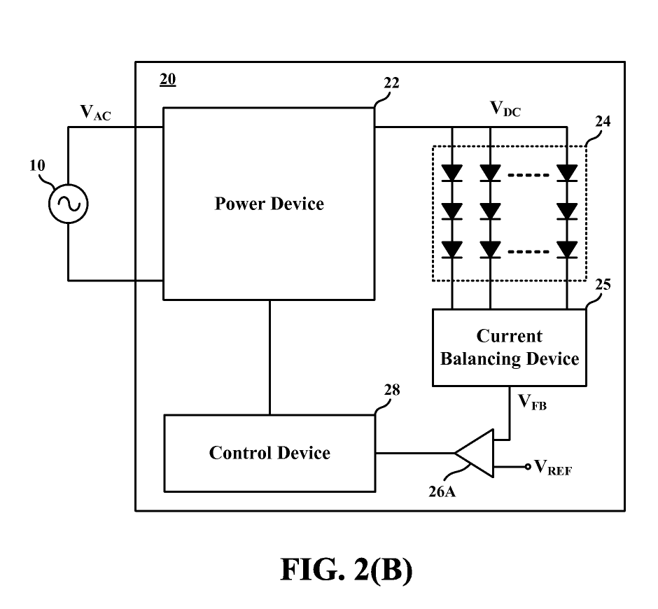

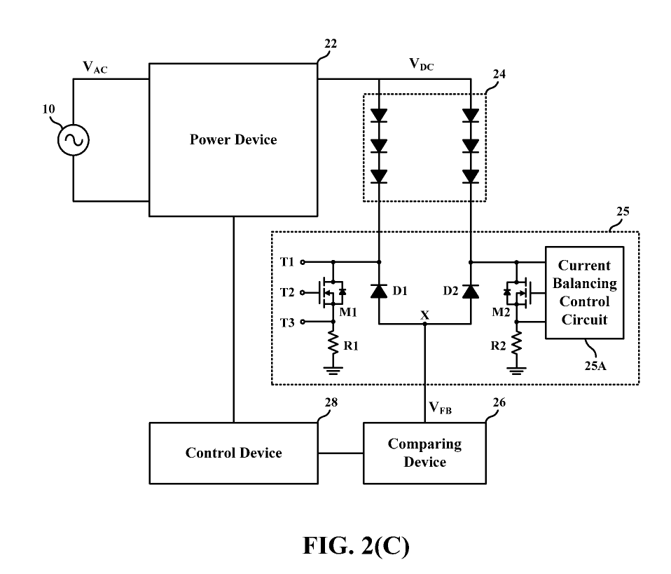

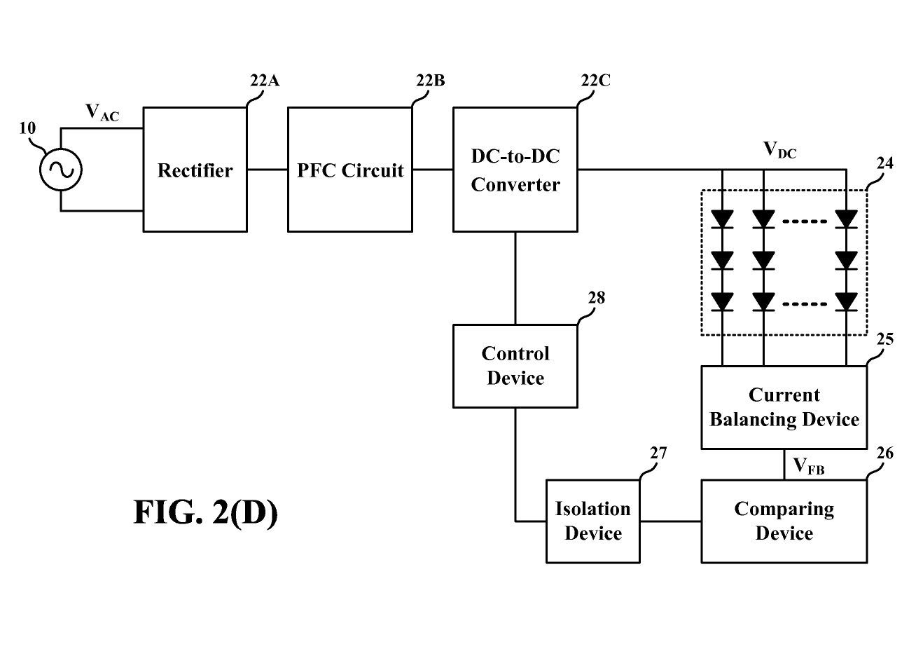

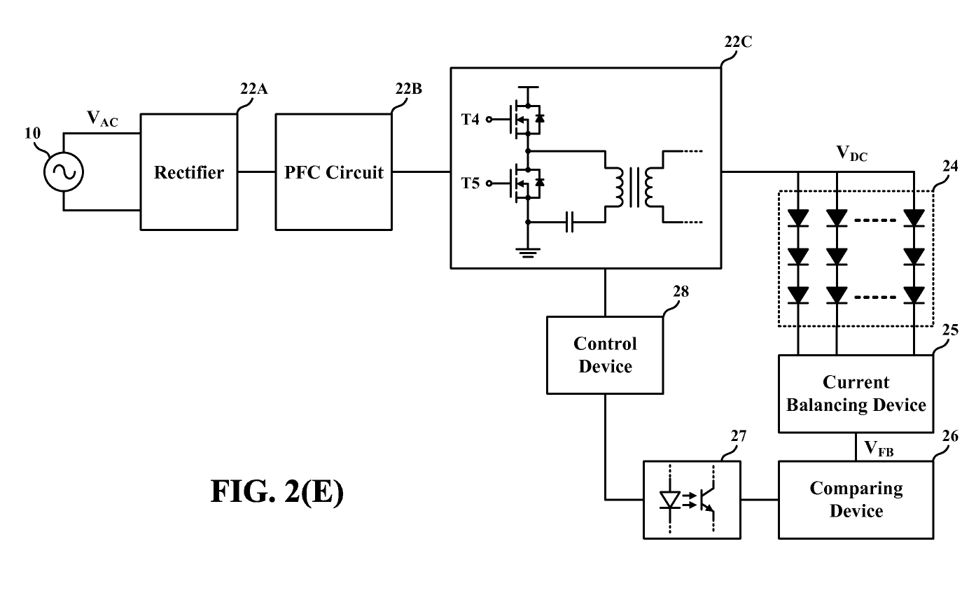

Please refer to FIG. 2(A), which illustrates the LED lighting system in the first embodiment according to the invention. As shown in FIG. 2(A), the LED lighting system 20 includes a power device 22, an LED device 24, a current balancing device 25, a comparing device 26, and a control device 28. In actual applications, the LED device 24 can include one set or plural sets of LEDs connected in series.

In this embodiment, the power device 22 receives an AC voltage (V_{AC}) from the commercial power port 10. The power device 22 converts the AC voltage (V_{AC}) into a DC voltage (V_{DC}) and provides the DC voltage (V_{DC}) to the LED device 24. In other words, the power device 22 is mainly used for providing the function of AC-to-DC converting. The magnitude of the DC voltage (V_{DC}) is determined according to the requirement of the LED device 24.

As shown in FIG. 2(A), the current balancing device 25 is coupled to the LED device 24 and generates a feedback voltage (V_{FB}) based on an operation condition of the LED device 24. The comparing device 26 is used for comparing the feedback voltage (V_{FB}) with a reference voltage (V_{REF}). For instance, if a certain set of LEDs in the LED device 24 does not acquire sufficient voltage, the feedback voltage (V_{FB}) generated by the current balancing device 25 would be lower than the reference voltage (V_{REF}). Accordingly, the comparing device 26 can generate a corresponding comparing result and provide the result to the control device 28. The control device 28 then generates a control signal based on the comparing result to request the power device 22 to raise the DC voltage V_{DC}. In other words, the DC voltage V_{DC} in this embodiment is adjustable. In actual applications, the control device 28 according to the invention can be implemented by the IC numbered TI UCC25600 fabricated by Texas Instrument. The control signal generated by the control device 28 can be a pulse-width modulation signal or a frequency modulation signal.

As shown in FIG. 2(B), the comparing device 26 can include a voltage comparator 26A. The first input terminal of the comparator 26A is connected to the current balancing device 25 to access the feedback voltage (V_{FB}). The second input terminal of the comparator 26A is connected to a reference voltage port (V_{REF}). In this embodiment, when V_{FB} is lower than V_{REF}, the control device 28 would request the power device 22 to increase V_{DC}. On the contrary, when V_{FB} is higher than V_{REF}, the control device 28 would request the power device 22 to decrease V_{DC}.

Please refer to FIG. 2(C), which further illustrates a detailed example of the current balancing device 25 according to the invention. To simplify the figure, only two sets of LEDs are shown in this example. The current balancing device 25 in this example includes two resistors (R1 and R2), two diodes (D1 and D2), two MOSFETs (M1 and M2), and a current balancing control circuit 25A. The nodes labeled as T1, T2, and T3 are all connected to the current balancing control circuit 25A.

As shown in FIG. 2(C), the three terminals of the two MOSFETs (M1 and M2) are respectively coupled to the current balancing control circuit 25A. The current balancing control circuit 25A controls the two MOSFETs and forces the currents flowing through the two resistors (R1 and R2) to be the same. The first terminals of the two diodes are respectively coupled to the corresponding LED set. The second terminals of the two diodes are coupled together at the node labeled as X. The voltage at the node X is the aforementioned feedback voltage (V_{FB}). In actual applications, the current balancing control circuit 25A can be implemented by the IC numbered GS7L05 fabricated by NIKO Semiconductor.

Please refer to FIG. 2(D), which further illustrates a detailed example of the power device 22 according to the invention. As shown in FIG. 2(D), the power device 22 in this example includes a rectifier 22A, a power factor correction (PFC) circuit 22B, and a DC-to-DC converter 22C. The rectifier 22A includes a plurality of diodes connected in a specific order and is used for preliminary converting the AC voltage V_{AC} into a DC voltage. In actual applications, the rectifier 22A can be a full-wave rectifier.

The PFC circuit 22B is connected between the rectifier 22A and the DC-to-DC converter 22C. Power factor is used for representing the relationship between the effective power and the total power consumption, i.e. the ratio of dividing the effective power by the total power consumption. Power factor can be used for evaluating how efficiently power is utilized. Larger power factor represents higher power utilization. With the PFC circuit 22B, the whole efficiency of the LED lighting system 20 can be raised.

The DC-to-DC converter 22C is used for converting the DC voltage outputted by the PFC circuit 22B into the DC voltage V_{DC} suitable for the LED device 24. In actual applications, the DC-to-DC converter 22C according to the invention can be a push-pull converter, a full-bridge converter, a half-bridge converter, a DC boost converter, a DC buck converter, or a flyback converter, but not limited to these examples. As shown in FIG. 2(C), the control signal generated by the control device 28 in this example is used for controlling the DC-to-DC converter 22C in the power device 22. The DC voltage V_{DC} provided to the LED device 24 is accordingly adjusted.

Further, in the example shown in FIG. 2(D), an isolation device 27 is arranged between the comparing device 26 and the control device 28. The isolation device 27 is used for isolating the circuits at the high voltage side and the circuits at the low voltage side, so as to comply with safety specifications. The comparing result generated by the comparing device 26 at the low voltage side is transmitted to the control device 28 at the high voltage side via the isolation device 27. In actual applications, the isolation device 27 can be implemented by an opto-coupler or an isolating transformer. The isolation device 27 is unnecessary if the DC-to-DC converter 22C is in the low voltage side (for example, when a DC boost converter or a DC buck converter is used.)

Please refer to FIG. 2(E), which illustrates more exemplary detail of the DC-to-DC converter 22C and the isolation device 27. The DC-to-DC converter 22C shown in FIG. 2(E) is a half-bridge converter and the isolation device 27 is implemented by an opto-coupler. The gates (labeled as T1 and T2) of the two MOSFETs in this converter can be controlled by the control device 28; the output voltage of the DC-to-DC converter 22C is accordingly adjusted.

The second embodiment according to the invention is a power system for driving an LED device. This power system includes the power device 22, the current balancing device 25, the comparing device 26, and the control device 28 in FIG. 2(A). As described above, the power device 22 is used for providing a DC voltage to the LED device. The current balancing device 25 is coupled to the LED device and generates a feedback voltage. The comparing device 26 compares the feedback voltage with a reference voltage and generates a comparing result. The control device 28 generates a control signal based on the comparing result. The power device 22 adjusts the DC voltage V_{DC} according to the control signal. In actual applications, the control signal can be a pulse-width modulation signal or a frequency modulation signal.

Same as the previous embodiment, the power device 22 in this embodiment can also include a rectifier 22A, a PFC circuit 22B, and a DC-to-DC converter 22C as shown in FIG. 2(D). Also, the control device 28 can control the DC voltage V_{DC} outputted by the DC-to-DC converter 22C. Further, the power system in this embodiment can also include an isolation device for isolating the control device 28 located at the high voltage side and the comparing device 26 located at the low voltage side. Same as the previous embodiment, the DC-to-DC converter 22C can be implemented with a half-bridge converter; the isolation device 27 can be implemented with an opto-coupler. The isolation device 27 is unnecessary if a DC boost converter or a DC buck converter is used in the DC-to-DC converter 22C.

Same as the previous embodiment, the current balancing device 25 in this example can include two resistors, two diodes, two MOSFETs, and a current balancing control circuit. The voltage at the node X where the two MOSFET are coupled together is the feedback voltage transmitted to the comparing device 26. In actual applications, the current balancing control circuit can be implemented by the IC numbered GS7L05 fabricated by NIKO Semiconductor.

As described above, a new structure for the power system of LED light sources is provided. By adjusting the circuit at the high voltage side according to the operation current of LEDs, the power system according to the invention can achieve the effect of providing proper voltage for LEDs without needing the boost/buck unit in prior arts. Further, in the power system according to the invention, the DC voltage V_{DC} is adjusted directly based on the condition of the LED lighting source; power would not be wasted in a boost/buck unit. The power system according to the invention can be widely applied in various electronic products that utilize LEDs as light sources.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An LED lighting system, comprising:
an LED device;
a current balancing device coupled to the LED device, for generating a feedback voltage based on an operation condition of the LED device;
a comparing device coupled to the current balancing device, for comparing the feedback voltage with a reference voltage and generating a comparing result;
a power device for providing a DC voltage to the LED device; and
a control device coupled between the comparing device and the power device, for generating a control signal based on the comparing result, the power device optionally adjusting the DC voltage according to the control signal.

2. The LED lighting system of claim 1, wherein the LED device comprises one set or plural sets of LEDs connected in series.

3. The LED lighting system of claim 1, wherein when the feedback voltage is lower than the reference voltage, the control device requests the power device to raise the DC voltage; when the feedback voltage is higher than the reference voltage, the control device requests the power device to reduce the DC voltage.

4. The LED lighting system of claim 1, wherein the power device comprises a DC-to-DC converter and the power device optionally adjusts the DC voltage outputted by the DC-to-DC converter according to the control signal.

5. The LED lighting system of claim 4, wherein the DC-to-DC converter is a push-pull converter, a full-bridge converter, a half-bridge converter, a DC boost converter, a DC buck converter, or a flyback converter.

6. The LED lighting system of claim 4, wherein the power device further comprises a power factor correction circuit coupled between the DC-to-DC converter and an AC power port for providing an AC voltage, and the power factor correction circuit is used for providing a power factor correction function.

7. The LED lighting system of claim 1, further comprising an isolation device coupled between the comparing device and the control device.

8. The LED lighting system of claim 7, wherein the isolation device comprises an opto-coupler or an isolating transformer.

9. The LED lighting system of claim 1, wherein the control signal is a pulse-width modulation signal or a frequency modulation signal.

10. A power system for driving an LED device, comprising:
a current balancing device coupled to the LED device, for generating a feedback voltage based on an operation condition of the LED device;
a comparing device coupled to the current balancing device, for comparing the feedback voltage with a reference voltage and generating a comparing result;
a power device for providing a DC voltage to the LED device; and
a control device coupled between the comparing device and the power device, for generating a control signal based on the comparing result, the power device optionally adjusting the DC voltage according to the control signal.

11. The power system of claim 10, wherein the LED device comprises one set or plural sets of LEDs connected in series.

12. The power system of claim 10, wherein when the feedback voltage is lower than the reference voltage, the control device requests the power device to raise the DC voltage; when the feedback voltage is higher than the reference voltage, the control device requests the power device to reduce the DC voltage.

13. The power system of claim 10, wherein the power device comprises a DC-to-DC converter and the power device optionally adjusts the DC voltage outputted by the DC-to-DC converter according to the control signal.

14. The power system of claim 13, wherein the DC-to-DC converter is a push-pull converter, a full-bridge converter, a half-bridge converter, a DC boost converter, a DC buck converter, or a flyback converter.

15. The power system of claim 13, wherein the power device further comprises a power factor correction circuit coupled between the DC-to-DC converter and an AC power port for providing an AC voltage, and the power factor correction circuit is used for providing a power factor correction function.

16. The power system of claim 10, further comprising an isolation device coupled between the comparing device and the control device.

17. The power system of claim 16, wherein the isolation device comprises an opto-coupler or an isolating transformer.

18. The power system of claim 10, wherein the control signal is a pulse-width modulation signal or a frequency modulation signal.
